(19) United States
(12) Patent Application Publication
(10) Pub. No.: US 2012/0153870 A1
(43) Pub. Date: Jun. 21, 2012

(54) Lighting Control Desk with Removable Touch Screen Device

(76) Inventors: Peter Kirkup, Newport (GB); Kenneth Walma, Atlanta, GA (US)

(21) Appl. No.: 12/970,462

(22) Filed: Dec. 16, 2010

(51) Int. Cl. H05B 37/02

(52) U.S. Cl. 315/312

(57) ABSTRACT

A lighting control desk having a removable touch screen device is provided. The lighting control desk includes a multitude of surface mounted control devices for adjusting attributes of lights and other devices. The touch screen device enables a user to configure, control, and monitor information associated with the lights and other devices controlled by the lighting control desk when attached to and when detached from the lighting control desk. The lighting control desk includes a receptacle for receiving the touch screen device in the form of a cavity in the lighting desk's control surface or in the form of a docking station. The touch screen device can communicate with the lighting control desk via multiple wireless technologies and via a wired connection, such as a Universal Serial Bus (USB) connection.

### TECHNICAL FIELD

The invention relates generally to lighting control desks and more particularly to a lighting control desk having a removable touch screen device operable to control, configure, and display information associated with lights and other devices controlled by the lighting control desk.

### BACKGROUND

A lighting control desk, sometimes referred to as a lighting control console or lighting board is an electronic device used to control multiple lights. For example, lighting control desks are commonly used to direct or control lighting in theaters, concert halls, and many other venues. Many lighting control desks typically control dimmers that adjust the intensity of lights. In addition, some conventional lighting control desks control automated lighting, such as lights that can move and lights that can change color, as well as other special effects devices.

Lighting control desks typically include several components that enable an operator or lighting designer to control lights. For example, many conventional lighting control desks include several faders (control slides) or banks of faders for controlling the brightness of lights. Some conventional lighting control desks also include numerical keypads, encoders, and/or user definable buttons or keys. These components can be adjusted by an operator to control an attribute, such as brightness, color, or mode, of a light controlled by the lighting control desk.

Some more advanced lighting control desks also include an integrated, non-removable touch screen that enables an operator to control lights and to monitor playback of recorded light states or shows. However, lighting control desks that employ an integrated, non-removable touch screen are typically much more expensive than those that do not include touch screens, limiting their use to higher end applications, such as large theaters and concert halls. Smaller venues, such as dance clubs and smaller theaters, typically can not justify this expense.

### SUMMARY

The present invention provides a lighting control desk having a removable touch screen device. The touch screen device can control, configure, and display information associated with lights and other devices controlled by the lighting control desk when the touch screen device is attached to the lighting control desk and when the touch screen device is detached from the lighting control desk. The lighting control desk can include several additional control components, such as faders, numerical keypads, user configurable buttons or keys, and encoders. The touch screen device can control lights (and other devices) in parallel with the other control components.

The lighting control desk can include a receptacle for holding the touch screen device. This receptacle can include a docking station or cradle adapted to hold the touch screen device and provide an electrical connection between the touch screen device and the lighting control desk. The docking station can include an electrical plug connector, such as a Universal Serial Bus (USB) connector, that engages an electrical connector of the touch screen device. This connection can enable communication between the touch screen device and the lighting control desk. Alternatively, the receptacle can include a cavity formed on a surface of the lighting control desk for receiving the touch screen device. The cavity can include an electrical connector for engaging an electrical connector of the touch screen device. The cavity may also include a mechanism for removably coupling the touch screen device to the lighting control desk. The cavity may be positioned adjacent other control components, such as faders or encoders on the surface.

The lighting control desk can include a wireless transceiver (transmitter and/or receiver) for communicating with a wireless transceiver of the touch screen device. These wireless transceivers can communicate via Bluetooth, General Packet Radio Service (GPRS), Near Field Communication (NFC), Wi-Fi, induction, or any other appropriate wireless technology. An operator can use the touch screen device to control, configure, and monitor lights and other devices that are controlled by the lighting control desk via this wireless communication and via the electrical connection provided by the receptacle.

These and other aspects, features, and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

For a more complete understanding of the exemplary embodiments of the present invention and the advantages thereof, reference is now made to the following description in conjunction with the accompanying drawings in which:

FIG. 1 is a block diagram depicting an operating environment for a lighting control desk having a removable touch screen device, in accordance with certain exemplary embodiments;

FIG. 2 is a perspective view of the lighting control desk of FIG. 1, in accordance with certain exemplary embodiments;

FIG. 3 is a perspective view of the lighting control desk of FIG. 1, in accordance with certain exemplary embodiments; and

FIG. 4 is a perspective view of an alternative embodiment for a lighting control desk having a removable touch screen device, in accordance with certain exemplary embodiments.

The drawings illustrate only exemplary embodiments of the invention and are therefore not to be considered limiting of its scope, as the invention may admit to other equally effective embodiments. The elements and features shown in the drawings are not necessarily to scale, emphasis instead being placed upon clearly illustrating the principles of exemplary embodiments of the present invention. Additionally, certain dimensions may be exaggerated to help visually convey such principles.

### DETAILED DESCRIPTION OF EXEMPLARY EMBODIMENTS

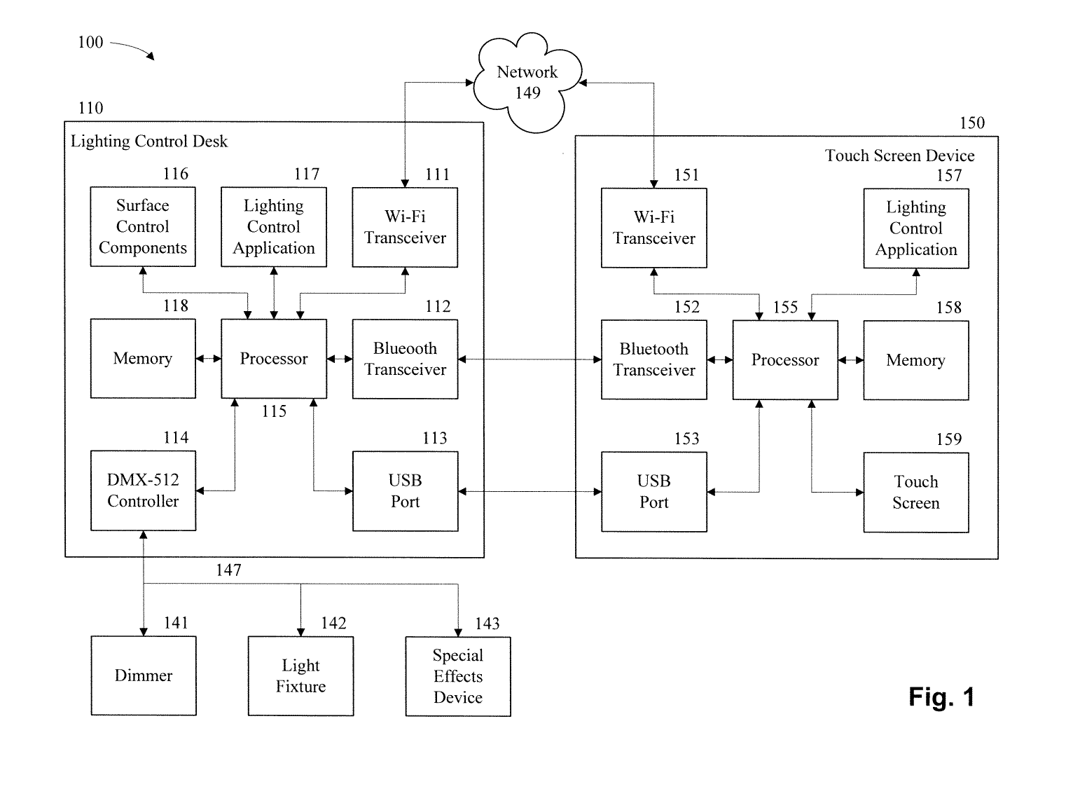

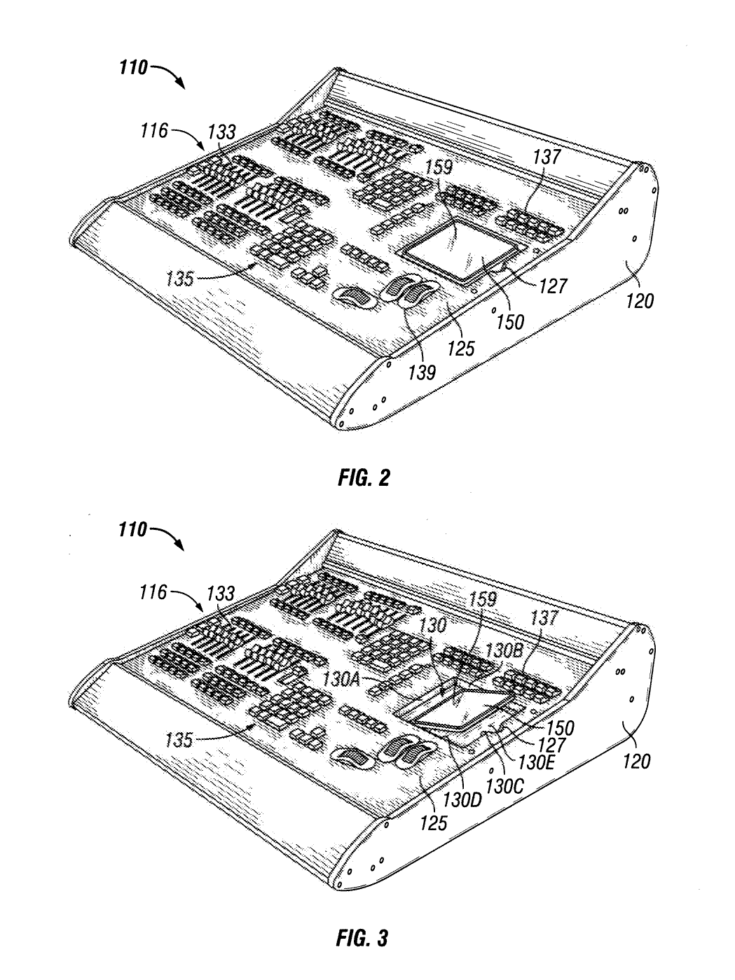

Referring now to the figures, in which like numerals represent like (but not necessarily identical) elements throughout the figures, exemplary embodiments of the present invention are described in detail. FIGS. 1-3 depict an exemplary lighting control desk 110 having a removable touch screen device 150 and an operating environment 100 for the lighting control desk 110. In particular, FIG. 1 is a block diagram depicting an exemplary operating environment 100; FIG. 2 is a perspective view of the exemplary lighting control desk 110 with the touch screen device 150 attached to the lighting control desk 110; and FIG. 3 is a perspective view of the lighting control desk 110 with the touch screen device 150 partially removed.

Referring to FIGS. 1-3, lighting control desks 110 are typically used to control multiple lights and other devices in situations including, but not limited to, dance clubs, theaters, concert stages, and the like. The exemplary lighting control desk 110 enables a user to configure, control, and monitor lights and other devices controlled by the lighting control desk 110 using the touch screen device 150, which is removable from the lighting control desk 110 and includes a touch sensitive display 159. In certain exemplary embodiments, the removable touch screen device 150 is a proprietary device for use with the lighting control desk 110 and provided with or as an accessory to the lighting control desk 110. In alternative exemplary embodiments, the lighting control desk 110 is configured for use with third party touch screen devices 150, as discussed in further detail below. In the alternative exemplary embodiment, the lighting control desk 110 is configured for use with one or more mobile telephones having a touch screen, such as an APPLE IPHONE, a BLACKBERRY, or a mobile telephone having a GOOGLE ANDROID platform or a MICROSOFT WINDOWS platform. This enables the lighting control desk 110 to be marketed at a much lower price compared to lighting control desks having an integrated, non-removable touch screen or other type of display. Instead, a user provides their own touch screen device 150, which the user may already own or otherwise have access to.

As shown in FIGS. 2 and 3, the exemplary lighting control desk 110 includes a housing 120 having a control surface 125. A multitude of components 116 are disposed on the control surface 125 for controlling lights, automated lights (e.g., lights that move, lights that changes colors, and gobo patterns), and other special effects devices, such as hazers and fog machines. In particular, the lighting control desk 110 includes faders (control slides) 133, pushbutton switches 137, encoders 139, and keypads 135. The lighting control desk 110 can also include other types of control devices known to those of ordinary skill in the art in addition to those shown or in place of those shown without affecting the operation of the invention.

The faders 133 move in two directions (e.g., front and back or left and right) along an axis to adjust an attribute (e.g., brightness, color, direction, orientation, mode, etc.) of one or more of the lights or devices controlled by the lighting control desk 110. The pushbutton switches 137 are actuated to activate or deactivate one or more lights, devices, or an attribute of one or more lights or devices. The encoders 139 typically rotate in both the clockwise and counterclockwise direction to adjust an attribute of the one or more of the lights or devices. The faders 133, pushbutton switches 137, and encoders 139 are typically programmed for a desired use based on the preference of a user.

The keypads 135 include numeric or alphanumeric keypads for configuring one or more lights or devices and for adjusting an attribute of one or more of the lights or devices controlled by the lighting control desk 110. The keypads 135 are generally used in conjunction with a display device, such as a liquid crystal display (LCD) screen (not shown) or the touch screen device 150 to configure or control a light or device. In one example, the keypads 135 are used to configure a network address for a light. In another example, the keypads 135 are used to enter a setting for a light, such as an intensity level, mode, or color.

As best seen in FIG. 3, the housing 120 of the lighting control desk 110 includes a cavity 130 having a bottom surface 130e and four walls 130a-130d. The cavity 130 holds the touch screen device 150 with the lighting control desk 110 such that a user can view and interact with the touch sensitive screen 159. Although in the illustrated embodiment the cavity 130 is substantially square-shaped, any other geometric or non-geometric shapes, such as rectangular and round are also feasible. The cavity 130 is adapted to receive and hold the touch screen device 150 with the lighting control desk 110. In certain exemplary embodiments, the depth of the cavity 130 substantially matches the thickness of the touch screen device 150, such that when the touch screen device 150 is disposed in the cavity 130, the display of the touch screen device 150 is flush or nearly flush with the control surface 125. In certain exemplary embodiments, the shape of the cavity 130 substantially matches the shape of the touch screen device 150. The cavity 130 also includes a finger notch 127 that facilitates removal of the touch screen device 150 from the cavity 130.

In certain exemplary embodiments, the cavity 130 is configured to receive a third party touch screen device 150, such as an APPLE IPHONE or BLACKBERRY. That is, the cavity 130 can be shaped similar to the third party touch screen device 150 and have a depth that matches or is similar to the thickness (measured from side of the device having the touch sensitive screen 159 to a side opposite the touch screen side) of the third party touch screen device 150. In certain exemplary embodiments, the cavity 130 is configured to receive a multitude of third party touch screen devices 150. For example, the cavity 130 may be large enough (in depth, length, and width) to receive a certain third party touch screen device 150. In certain exemplary embodiments, mounting brackets or other mechanical structures are removably disposed in the cavity 130 to hold smaller touch screen devices 150. In certain exemplary embodiments, the cavity 130 is configured to receive larger third party touch screen devices, such as a tablet computer (e.g., an APPLE IPAD).

In certain exemplary embodiments, the cavity 130 includes one or more mechanical devices, structures, or components (not shown) for removably holding the touch screen device 150. For example, the cavity 130 includes one or more clips, tabs, appendages, projections, or protrusions extending from the surface 125 and over a portion of the touch screen device 150 to hold the touch screen device 150 in place. In certain exemplary embodiments, the cavity 130 or surface 125 includes one or more magnets for engaging a magnet or ferromagnetic material of the touch screen device 150. In certain alternative embodiments, rather than employing a cavity 130, the lighting control desk 110 includes a compartment having a window such that the touch screen device 150 can be slidably inserted into the compartment. In this embodiment, a user interacts with the touch screen device 150 via the window.

In certain exemplary embodiments, the cavity 130 also includes one or more electrical connectors (not shown) that couples or attaches to an electrical connector of the touch screen device 150. In certain exemplary embodiments, the cavity 130 can include an electrical receptacle for receiving an electrical plug protruding from the touch screen device 110. This electrical receptacle can be positioned on one of the walls 130a-130d or on the surface 130e. In certain exemplary embodiments, the cavity 130 includes an electrical plug protruding from one of the walls 130a-130d or from the surface 130e to engage an electrical receptacle of the touch screen device 110. In certain exemplary embodiments, the electrical connectors are USB connectors.

In alternative embodiments, the cavity 130 includes multiple types of connectors for connecting to different types, models, or designs of touch screen devices 150. In one example, the cavity 130 includes several types of USB plugs, such as USB Standard Type A, USB Standard Type B, mini-USB, and/or micro-USB. Other types of connectors could also be included in certain exemplary embodiments.

As shown in FIG. 1, the lighting control desk 110 communicates with dimmers 141, light fixtures 142 (e.g., intelligent light fixtures that can change the color of lights or move lights), and special effects devices 143, such as a fog machine or hazer. In the illustrated embodiment, the lighting control desk 110 includes a DMX-512 controller 114 for communicating with the devices 141-143 via DMX-512 compliant cables 147 in a DMX-512 network. In addition, or in the alternative, the lighting control desk 110 communicates with the devices 141-143 using a different control protocol than DMX-512, such as an Architecture for Control Networks (ACN) protocol or a DMX-512A protocol. Other protocols, such as 0-10 V and 4-20 mA analog control, are also feasible.

The exemplary lighting control desk 110 includes a processor 115, memory 118, and a lighting control application 117. The processor 115 can include a microprocessor, a central processing unit (CPU), a microcontroller, or other appropriate technology. In certain exemplary embodiments, the processor 115 is programmed, configured, or otherwise adapted to communicate with other devices, such as the touch screen device 150, via several different wireless technologies, including, but not limited to, Bluetooth, Wi-Fi, General Packet Radio Service (GPRS), Near Field Communication (NFC), near field magnetic induction, ZigBee, etc.

The lighting control application 117 is executed by the processor 115 to control, configure, and display information associated with the devices 141-143. The lighting control application 117 can be implemented as software, hardware, or a combination thereof. The memory 118 can include volatile and non-volatile machine-readable memory, such as RAM, ROM, a hard disk, removable media, flash memory, memory stick, optical media, magneto-optical media, CD-ROM, etc. The memory 118 facilitates the execution of the lighting control application 117 and is also capable of storing recorded light states or shows for playback. In certain exemplary embodiments, the memory 118 also stores configurations for the devices 141-143.

The lighting control application 117 adjusts attributes of the devices 141-143 controlled by the lighting control desk 110 based on inputs received from the components 116 disposed on the control surface 125, inputs received from a client lighting control application 157 executing on the touch screen device 150, and based on recorded light states or shows, for example stored in memory 118. The lighting control application 117 is capable of communicating with the components 116 and the client lighting control application 157 simultaneously such that the components 116 and the client lighting control application 157 controls the devices 141-143 in parallel. In one example, a user adjusts an attribute of a first light using a fader 133 while also adjusting an attribute of a second light using the client lighting control application 157. The parallel control is enabled when the touch screen device 150 is attached to the lighting control desk 110 and when the touch screen device 150 is detached from the lighting control desk 110. For example, a first user can control an attribute of a first light using the touch screen device 150 from a location remote from the lighting control desk 110, while a second user controls an attribute of the first light or an attribute of a second light using one of the components 116.

The touch screen device 150 includes a processor 155 (e.g., microprocessor, CPU, etc.) that executes the client lighting control application 157 via memory 158. The memory 158 can include volatile and non-volatile machine readable memory, such as RAM, ROM, a hard disk, removable media, flash memory, memory stick, optical media, magneto-optical media, CD-ROM, etc. The memory 158 is capable of storing recorded light states or shows for playback and configurations for the devices 141-143, similar to the memory 118. The client lighting control application 157 synchronizes these configurations and light states/shows with the lighting control application 117. This synchronization typically occurs in response to a change, periodically, in response to a user command, or in response to the touch screen device 150 being attached to or in communication with the lighting control desk 110.

The exemplary lighting control desk 110 includes several modules for communicating with the touch screen device 150. In the illustrated embodiment, the lighting control desk includes a Wi-Fi transceiver 111, a Bluetooth transceiver 112, and a USB port 113. Similarly, the exemplary touch screen device 150 includes a Wi-Fi transceiver 151, a Bluetooth transceiver 152, and a USB port 153 for communicating with the corresponding module of the lighting control desk 110. Other communication technologies can also be used, such as GPRS, NFC, ZigBee, etc. Many conventional touch screen devices, such as mobile phones and tablet computers, come equipped with a Wi-Fi transceiver 151, a Bluetooth transceiver 152, and a USB port 153, among other communication technologies. Employing one or more of the Wi-Fi transceiver 111, the Bluetooth transceiver 112, and the USB port 113 enables the lighting control desk 110 to communicate with many conventional third party touch screen devices.

The Wi-Fi transceivers 111, 151 enable the touch screen device 150 to communicate with the lighting control desk 110 via a distributed network 149, such as a local area network (LAN), a wide area network (WAN), or the Internet. In certain exemplary embodiments, the distributed network 149 includes one or more wireless access points (not shown) and the Wi-Fi transceivers 111, 151 communicate via the wireless access point(s). In certain exemplary embodiments, the lighting control desk 110 is connected to (e.g., via Ethernet cable) or includes a wireless access point in place of the Wi-Fi transceiver 111.

The Bluetooth transceivers 112, 152 enable the touch screen device 150 to communicate with the lighting control desk 110 via a direct wireless connection. Other direct wireless connections can also be used in addition to or in place of this Bluetooth connection. For example, GPRS, NFC, and/or ZigBee may be used in certain exemplary embodiments. In addition, a proprietary wireless technology may also be used in certain exemplary embodiments.

The USB ports 113, 153 provide a wired connection between the touch screen device 150 and the lighting control desk 110. As discussed above, the cavity 130 can include an electrical connector for engaging an electrical connector of the touch screen device 150. In the exemplary embodiment of FIG. 1, these electrical connectors include USB ports 113, 153. Many conventional touch screen devices include a USB port 153 in the form of a receptacle for communications with another device (e.g., a computer) and battery charging. In certain exemplary embodiments, the cavity 130 includes a USB port 113 in the form of a plug for engaging the receptacle of the touch screen device 150. In certain exemplary embodiments, the lighting control desk 110 includes a USB receptacle for receiving a USB plug. For example, a USB cable is connected to a USB receptacle of the lighting control desk 110 and a USB receptacle of the touch screen device 150. In such an embodiment, the touch screen device 150 is free to move rather than being connected in a fixed location on the lighting control desk 110. Although the illustrated embodiment employs USB ports 113 and 153, other wired connections known to those of ordinary skill in the art may be used without departing from the scope and spirit of the present invention.

In certain exemplary embodiments, the lighting control desk 110 includes an induction communication system, such as a near field magnetic induction communication system, for communicating with an induction communication system of the touch screen device 150. The induction communication systems provide short distance communication between the lighting control desk 110 and the touch screen device 150. In certain exemplary embodiments, this short distance communication replaces the wired connection between the lighting control desk 110 and the touch screen device 150. In one example, induction communication systems are used in embodiments employing magnets for coupling the touch screen device 150 to the lighting control desk 110. In another example, the lighting control desk 110 and the touch screen device 150 each include a near field magnetic induction communication system.

The exemplary client lighting control application 157 provides a multitude of functions relating to the lights and other devices 141-143 controlled by the lighting control desk 110. The client lighting control application 157 enables a user to configure a light or other device with the lighting control desk 110. In one example, a user specifies a network address (e.g., DMX-512 address) for a dimmer 141, a light fixture 142, or a special effects device 143. The user can walk around a venue to each light controlled by the lighting control device 110 and associate the lights with a network address using the client lighting control application 157. The client lighting control application 157 synchronizes the addresses with the lighting control application 117.

In certain exemplary embodiments, the touch screen device 150 includes a Global Positioning System (GPS) receiver (not shown). In such embodiments, the client lighting control application 157 interacts with the GPS receiver to obtain the location of each device 141-143, for example during the configuration process. In one example, the user walks around a venue to configure devices 141-143. While configuring each device 141-143 (and thus being located proximal to the device 141-143), the user instructs the client lighting control application 157 to obtain the location of the touch screen device 150. In response, the client lighting control application 157 interacts with the GPS receiver to obtain the location of the touch screen device 150. The client lighting control application 157 stores the location in memory 158 and/or transmits the location to the lighting control application 117.

The client lighting control application 157 also enables a user to control lights and other devices 141-143 controlled by the lighting control desk 110. The client lighting control application 157 presents a user interface via the touch screen 159 for the user to adjust attributes of the devices 141-143. In one example, the client lighting control application 157 presents virtual sliders, encoders, and buttons operable to adjust an attribute of a device 141-143. In response to a user adjusting one of the attributes using this user interface, the client lighting control application 157 conveys the adjustment to the lighting control application 117, for example in real time or near real time. In response, the lighting control application 117 adjusts the attribute of the device 141-143. In certain exemplary embodiments, the client lighting control application 157 also conveys the adjustment to the device 141-143. For example, the client lighting control application 157 is capable of conveying the adjustment to the lighting control application 117 and the devices 141-143 at the same time or in parallel.

The client lighting control application 157 also enables a user to record a light show and store the recorded show in memory 158. The client lighting control application 157 transmits the recorded show to the lighting control application 117 for storage in memory 118. The client lighting control application 157 also enables a user to monitor playback of a light show or retrieve information associated with a device 141-143. A user can initiate a playback and monitor the playback using the client lighting control application 157. In certain exemplary embodiments, the lighting control application 117 performs the playback and adjusts attributes of the devices 141-143 according to the recorded light state/show. The lighting control application 117 also sends information regarding the playback to the client lighting control application 157 for display to the user. The user can select a channel and thus a device 141-143 to monitor, or monitor multiple channels simultaneously.

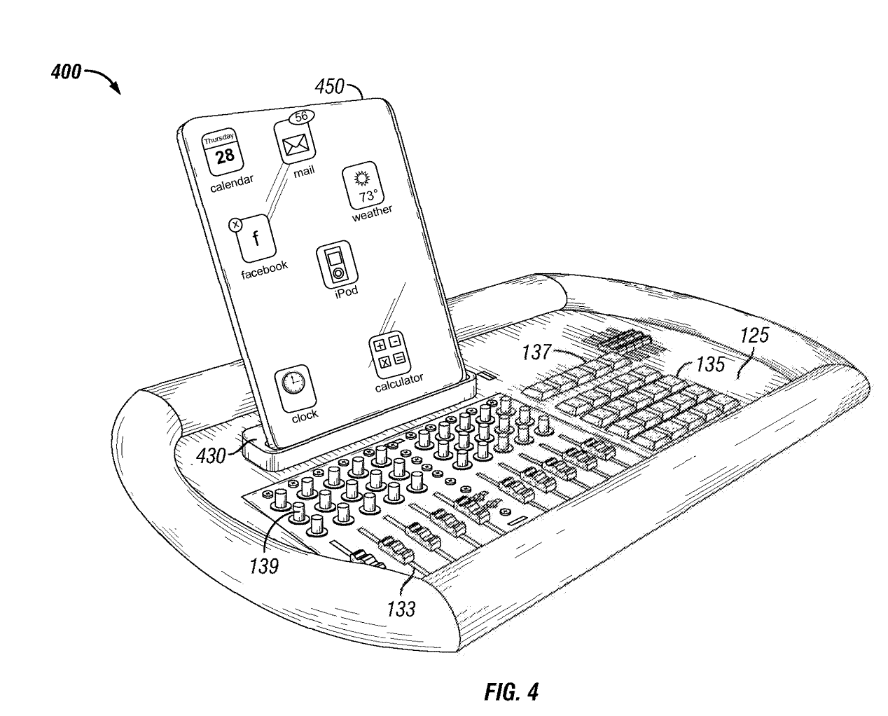

FIG. 4 is a perspective view of an exemplary embodiment for a lighting control desk 400 having a removable touch screen device 450, in accordance with alternative exemplary embodiments. Referring to FIG. 4, the exemplary lighting control desk 400 includes many of the same or similar components as the lighting control desk 100. For example, the lighting control desk 400 includes faders 133, a keypad 135, pushbutton switches 137, and encoders 139 mounted on a control surface 125. However, rather than having a cavity similar to the cavity 130, the exemplary lighting control desk 400 includes a docking station 430 or cradle for holding the touch screen 450. Further alternative embodiments include both a cavity similar to the cavity 130 and a docking station similar to the docking station 430.

The docking station 430 includes an electrical plug connector, such as a USB connector, than engages an electrical connector of the touch screen device 450. In certain exemplary embodiments, the touch screen device 450 includes a USB receptacle and the docking station 430 includes a USB plug that engages the USB receptacle. This connection enables communication between the touch screen device 450 and the lighting control desk 400, similar to the USB ports 113, 153 discussed above. Other wired connections known to those of ordinary skill in the art may also be used without departing from the scope and spirit of the present invention.

In certain exemplary embodiments, the docking station 430 includes multiple types of connectors for connecting to different types, models, or designs of touch screen devices 450. In one example, the docking station 430 includes several types of USB plugs, such as USB Standard Type A, USB Standard Type B, mini-USB, and/or micro-USB. Other types of connectors could also be used in certain exemplary embodiments.

In certain exemplary embodiments, the lighting control desk 400 is configured to attach to multiple types, configurations, or designs of docking stations 430. This feature enables the lighting control desk 400 to connect to a multitude of touch screen devices 450. For example, a first type of docking station 430 is attached to the lighting control desk 400 for use with a first type of touch screen device 450, such as an APPLE IPHONE. This first type of docking station 430 can be removed and replaced with a second docking station for use with a BLACKBERRY. Thus, the exemplary lighting control desk 400 has interchangeable docking stations. In certain exemplary embodiments, the lighting control desk 400 is configured for use with a larger touch screen device 450, such as a tablet computer. In one example, the lighting control desk 400 includes a docking station 430 for holding an APPLE IPAD and facilitating communication between the lighting control desk 400 and the APPLE IPAD.

In certain exemplary embodiments, the lighting control desk 400 includes a recessed (or non-recessed) area in the control surface 125 for receiving different types of docking stations 430. In certain exemplary embodiments, this recessed area includes one or more electrical connectors for attaching to an electrical connector of the docking station 430 to enable wired communications between the touch screen device 450 and the lighting control desk 400. In certain exemplary embodiments, the lighting control desk 400 includes more than one docking station 430 disposed on the control surface 125, each docking station 450 being for a particular touch screen device 450.

The docking station 430 is positioned with respect to the control surface 125 to enable seamless lighting control when the touch screen device 450 is held in the docking station 430. Although in the illustrated embodiment, the docking station 430 is disposed near the middle (widthwise) of the control surface 125, in certain alternative embodiments, the docking station 430 is disposed on a side of the control surface 125. In certain exemplary embodiments, the lighting control desk 400 includes multiple docking stations 430, such that multiple touch screen devices 450 can be attached to the lighting control desk 400 and used simultaneously.

One of ordinary skill in the art would appreciate that exemplary embodiments provide a lighting control desk having a touch screen device. The touch screen device can control, configure, and display the status of lights and other devices controlled by the lighting control desk when the touch screen device is attached to the lighting control desk and when the touch screen device is detached from the lighting control desk. The lighting control desk can be adapted for use with a multitude of third party touch screen devices. This versatility allows for a lower priced lighting control desk relative to a lighting control desk having an integrated, non-removable touch screen. This versatility also allows users to select and provide their own touch screen device.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A lighting control desk, comprising:
a housing comprising a control surface;
a processing unit logically coupled to a plurality of lighting devices and operable to execute a lighting control application to control at least one attribute of each of the plurality of lighting devices;
a cavity formed in the control surface for removably holding a control device comprising a touch sensitive display;
a wired communication port comprising an electrical connector adapted to connect to a communication port of the control device, the wired communication port operable to provide wired communication between the processing unit and the control device when the electrical connector is connected to the communication port of the control device; and
a wireless communication module for providing wireless communication between the processing unit and the control device.

2. The lighting control desk of claim 1, wherein the electrical connector is disposed in the cavity.

3. The lighting control desk of claim 1, wherein the wired communication port comprises a Universal Serial Bus (USB) port.

4. The lighting control desk of claim 1, wherein the wireless communication module comprises at least one of a Wi-Fi transceiver, a Bluetooth transceiver, a General Packet Radio Service (GPRS) transceiver, a Near Field Communication (NFC) transceiver, and an induction communication system.

5. The lighting control desk of claim 1, further comprising at least one control component disposed on the control surface and operable to provide a control input to the processing unit.

6. The lighting control desk of claim 5, wherein the at least one control component comprises at least one of a fader, a keypad, and an encoder.

7. The lighting control desk of claim 5, wherein the processing unit is operable to control the at least one attribute of each of the plurality of lighting devices based on a control input received from the at least one control component and based on a control input received from the control device.

8. The lighting control desk of claim 1, wherein the cavity is configured to hold a mobile telephone.

9. The lighting control desk of claim 1, wherein the processing unit is operable to receive a control input from the control device identifying an adjustment to an attribute of one of the at least one lighting devices via the wired communication port or the wireless communication module and further operable to communicate the adjustment to the one lighting device.

10. The lighting control desk of claim 1, wherein the processing unit is operable to receive a configuration input from the control device identifying a configuration parameter for one of the lighting devices.

11. A lighting control console, comprising:
a control surface;
a processing unit logically coupled to a plurality of lighting devices and operable to control at least one attribute of each of the plurality of lighting devices;
a docking station configured to hold a control device having a touch sensitive screen and comprising an electrical connector adapted to connect to a communication port of the control device
a wired communication port logically connected to the electrical connector and to the processing unit and operable to provide wired communication between the processing unit and the control device when the electrical connector is connected to the communication port of the control device; and
a wireless communication module for providing wireless communication between the processing unit and the control device.

12. The lighting control console of claim 11, wherein the wired communication port comprises a Universal Serial Bus (USB) port and the electrical connector comprises a USB connector.

13. The lighting control console of claim 11, wherein the wireless communication module comprises at least one of a Wi-Fi transceiver, a Bluetooth transceiver, a General Packet Radio Service (GPRS) transceiver, a Near Field Communication (NFC) transceiver, and an induction communication system.

14. The lighting control console of claim 11, further comprising at least one control component disposed on the control surface and operable to provide a control input to the processing unit, the control input identifying an adjustment to one of the at least one lighting devices.

15. The lighting control console of claim 14, wherein the at least one control component comprises at least one of a fader, a keypad, and an encoder.

16. The lighting control console of claim 5, wherein the processing unit is operable to control the at least one attribute of each of the plurality of lighting devices based on a control input received from the at least one control component and based on a control input received from the control device.

17. The lighting control console of claim 11, wherein the docking station is configured to hold at least one of a mobile telephone and a tablet computer.

18. The lighting control console of claim 11, wherein the processing unit is operable to receive a control input from the control device identifying an adjustment to an attribute of one of the at least one lighting devices via the wired communication port or the wireless communication module and further operable to communicate the adjustment to the one lighting device.

19. The lighting control console of claim 11 wherein the processing is operable to receive a configuration input from the control device identifying a configuration parameter for one of the lighting devices.

20. The lighting control console of claim 11, wherein the docking station is mounted on the control surface.

21. The lighting control console of claim 11, wherein the docking station is disposed on the control surface proximal at least one hardware control component to facilitate lighting control for a user via the touch sensitive screen of the control device and the at least one hardware control component when the control device is coupled to the docking station.
